(19) United States
(12) Patent Application Publication
(10) Pub. No.: US 2012/0205549 A1
(43) Pub. Date: Aug. 16, 2012

(54) DETECTOR UNIT FOR DETECTING ELECTROMAGNETIC RADIATION

(75) Inventors: Matthias Simon, Aachen (DE); Walter Ruetten, Linnich (DE)

(73) Assignee: KONINKLIJKE PHILIPS ELECTRONICS N.V., EINDHOVEN (NL)

(21) Appl. No.: 13/501,508

(22) PCT Filed: Oct. 27, 2010
(86) PCT No.: PCT/IB10/54863

§ 371 Date: Apr. 12, 2012

(30) Foreign Application Priority Data
Nov. 3, 2009 (EP) 09174859.0

(51) Int. Cl. G01T 1/16

(52) U.S. Cl. 250/395; 250/336.1

(57) ABSTRACT

According to an exemplary embodiment of the invention a detector unit 301 for detecting electro-magnetic radiation may be provided. The detector unit 301 may comprise a conversion material 332 adapted for converting impinging electro-magnetic radiation into electric charge carriers. Moreover, the detector unit 301 may comprise a charge collection electrode 331 adapted for collecting the converted electric 321 charge carriers and an evaluation circuit 312, 313, 314 adapted for evaluating the electro-magnetic radiation based on the collected electric charge carriers. Moreover, the detector unit 301 may comprise a semiconductor 373 which may be electrically coupled between the charge 331 collection electrode 331 and the evaluation circuit 312, 313, 314.

### FIELD OF THE INVENTION

The present invention relates to a detector unit for detecting electromagnetic radiation, to a detector device and to a method of detecting electromagnetic radiation. Moreover, the invention relates to a computer-readable medium, in which a computer program of detecting electromagnetic radiation may be stored and to a program element of detecting electromagnetic radiation.

### BACKGROUND OF THE INVENTION

Currently most solid-state digital X-ray detectors in the market may be built of a flat glass plate with amorphous silicon (a-Si) thin film electronics and an X-ray conversion layer on top of it. The X-ray detectors may be either of the indirect conversion type with a scintillator on top of an array of photodiodes or of the direct conversion type using a photoconductor on top of an array of electrodes. The impinging X-rays are absorbed in the conversion layer and, via the generated charges in each pixel of the array, create a digital image of the X-ray absorption.

An alternative to thin film electronics on glass may be the use of wafers of monocrystalline silicon for the pixel electronics. As above, pixels with or without photodiodes can be built for either indirect or direct X-ray conversion. The use of standard CMOS processes in monocrystalline silicon may lead in general to electronic circuits with less noise and more functionality compared to a-Si pixel circuits. In case of an indirect conversion detector, the scintillator can either be glued or grown directly on the Si wafer. For direct X-ray conversion materials there might be also at least two possibilities: either connecting a separately fabricated layer, e.g. with bump balls or a direct deposition on silicon.

Today the pixel pitch in flat X-ray detectors may reach from about 150 μm to about 200 μm except for mammography and dental imaging, where pixel sizes of less than 100 μm are common. A general trend can be observed in X-ray imaging, that the demand for higher spatial resolution also for cardiology, neurology and vascular applications is growing. The pixel size of a monocrystalline Si-detector may be reduced to values far below 100 μm because of the small feature sizes, which may be possible with this technology for transistors and other electronic elements.

However, in the case of an indirect conversion detector, the spatial resolution may be limited by the light spread in the scintillator. In general the thickness of the scintillator may not be reduced to maintain a high X-ray absorption yield. To fully exploit the high spatial resolution of a detector with small pixels a direct X-ray conversion may be suited better. Direct conversion materials like selenium, mercury iodide, lead oxide or CdTe (Cadmium Telluride) can be easily made thick enough to absorb more than 80% of the X-rays with a beam quality typical for medical imaging. A very high spatial resolution may be usually achieved because the generated charge carriers which may be electrons and holes, may follow the field lines of the applied bias field, which may run perpendicular to the surface of the pixel electrode and the usually unstructured top electrode.

Besides the spatial resolution another advantage of a direct conversion CMOS detector may be the possibility to overcome the limited fill factor of a photodiode in a small pixel. In a direct conversion detector a metal layer covering nearly the whole pixel area can serve as pixel electrode.

### SUMMARY OF THE INVENTION

It is an object of the invention to improve a detector, especially to provide a sufficiently sensitive detector.

This object is achieved by the features of the independent claims relating to a detector unit, a detector device, a method of detecting electromagnetic radiation, a program element, and a computer-readable medium.

According to an exemplary embodiment of the invention a detector unit for detecting electro-magnetic radiation may be provided. The detector unit may comprise a conversion material adapted for converting impinging electro-magnetic radiation into electric charge carriers. Moreover, the detector unit may comprise a charge collection electrode adapted for collecting the converted electric charge carriers and an evaluation circuit adapted for evaluating the electro-magnetic radiation based on the collected electric charge carriers. Moreover, the detector unit may comprise a semiconductor which may be electrically coupled between the charge collection electrode and the evaluation circuit.

The principles of the invention may be applicable in different kinds of sensors, especially in image sensors, such as CMOS image sensors which may be used in X-ray devices and in X-ray detectors, especially in CMOS X-ray detectors. Thus, the principles of the invention may refer to an X-ray detector, which may use direct X-ray conversion combined with CMOS pixel circuits. The proposed pixel circuit may provide a very high sensitivity by means of an additional charge transfer step from the large pixel electrode to a dedicated small additional integration capacity. The effective input capacitance may be reduced in this case without the need of a permanent bias current like in other solutions. The main application of such a high sensitive direct conversion detector may be mammography, but it may be usable for many other X-ray imaging applications. It may also be foreseen that in front of the charge collection electrode or below the charge collection electrode there may be arranged a shielding electrode. This shielding electrode may be adapted to form a capacitance with the charge collection electrode. This may improve the capacitive characteristic of the detector unit.

According to an exemplary embodiment, the semiconductor of the detector unit may be a transistor, comprising a gate connection, a drain connection and a source connection, wherein the source connection may be connected to the charge collection electrode and the drain connection may be connected to the evaluation circuit.

The semiconductor may be of any type, for example a FET, especially a MOSFET.

According to an exemplary embodiment, the gate connection may be held to a predetermined voltage wherein the predetermined voltage may be adapted to provide a current flow of a source drain current from the charge collection electrode to the evaluation circuit.

It may be foreseen that the predetermined voltage is a timely constant voltage or permanent voltage of a predetermined value which may be applied during the whole operation time of the detector unit. It may also be possible that the applied voltage is a pulsed voltage, which may be applied in predetermined time intervals and which may be not present during the whole operating time due to the pulse characteristic.

According to an exemplary embodiment, an integration capacitance may be electrically coupled to the semiconductor and to the evaluation circuit.

The electrically coupling may be provided as a conducting connection between the integration capacitor and the semiconductor as well as between the semiconductor and the evaluation circuit. The integration capacitance may comprise a first connection and a second connection. The first connection may be electrically coupled to the semiconductor as well as to the evaluation circuit. The second connection may be connected to a reference potential, especially to a ground potential.

According to an exemplary embodiment of the invention, the integration capacitance may comprise a first connection and a second connection wherein the first connection may be connected to the drain connection of the transistor and the second connection may be connected to a reference potential.

The reference potential may be a ground potential.

According to an exemplary embodiment of the invention, the semiconductor may be connected to a charge pump.

It may also be possible that the charge pump may be connected to an input electrode, especially to the charge collection electrode of the detector unit.

According to an exemplary embodiment, the charge pump may be adapted to be controlled by a first control line.

The first control line may also be connectable to additional detector units in order to control different detector units with one control line.

According to an exemplary embodiment, the semiconductor may be connected to a first charge transfer transistor which may be adapted to be controlled by a second control line.

The semiconductor may comprise a gate connection which may be electrically connected to a control line. Furthermore, the semiconductor may comprise a drain connection which may be electrically connected to the first charge transfer transistor. The first charge transfer transistor may be a FET (field effect transistor), especially an n-channel transistor, which may comprise a gate connection, a drain connection and a source connection. The source connection of the first charge transfer transistor may be connected to the semiconductor.

According to an exemplary embodiment, the first charge transfer transistor may be connected to a first charge storage capacitor.

The first charge transfer transistor may function as a switch and may transfer in a closed status the charge from the integration capacitor to the first charge storage capacitor.

According to an exemplary embodiment of the invention, the first charge transfer transistor may be connected to a second charge transfer transistor which second charge transfer transistor may be adapted to be controlled by a third control line.

The second charge transfer transistor may function as a switch and may transfer in a closed status the charge from the first charge storage capacitor to the second charge storage capacitor. In addition it may be foreseen that further integration capacitors and further charge transfer transistors may be utilized in a chain like manner, similar as the first charge storage capacitor, the second charge storage capacitor, the first charge transfer transistor and the second transfer transistor are connected to each other.

According to an exemplary embodiment of the invention, the second charge transfer transistor may be connected to a second charge storage capacitor.

The second charge transfer transistor may be a FET (field effect transistor), especially an n-channel transistor, which may comprise a gate connection, a drain connection and a source connection. The gate connection of the second charge transfer transistor may be connected to a further control line.

According to an exemplary embodiment of the invention, a detector device for detecting electro-magnetic radiation may be provided. The detector device may comprise a plurality of interconnected detector units, according to an exemplary embodiment of the invention.

The detector device may comprise a matrix of detector units, which may be connected to each other with vertical control lines and horizontal control lines.

According to an exemplary embodiment of the invention, a method of detecting electro-magnetic radiation may be provided. The method may comprise converting impinging electro-magnetic radiation into electric charge carriers, collecting the converted electric charge carriers at the charge collection electrode. The method may further comprise providing a current flow from the charge collection electrode to an evaluation circuit and evaluating by an evaluation circuit the electro-magnetic radiation based on the collected electric charge carriers.

Providing a current flow from the charge collection electrode to the evaluation circuit may be provided by a semiconductor and/or a charge pump. Moreover, it may be foreseen to provide a shielding electrode adapted to form a capacitance with the charge collection electrode. Such a shielding electrode may provide an improved capacitance characteristic of the X-ray apparatus comprising several detector units. An improved capacitance may result in an improved control of picture evaluation of the X-ray apparatus using a plurality of detector units.

According to an exemplary embodiment of the present invention, a computer-readable medium may be provided in which a computer program of detecting electro-magnetic radiation may be stored, and which, when being executed by a processor may be adapted to control or carry out a method according to the invention.

A computer readable medium may be a floppy disk, a hard disk, an USB (Universal Serial Bus) storage device, a RAM (Random Access Memory), a ROM (Read Only Memory), an EPROM (Erasable Programmable Read Only Memory) or the like.

According to an exemplary embodiment of the invention, a program element of detecting electro-magnetic radiation may be provided. The program element when being executed by a processor may be adapted to control or carry out a method according to the invention.

These and other aspects of the invention will be apparent from and elucidated with reference to the embodiments described hereafter.

It has also to be noted that exemplary embodiments of the present invention and aspects of the invention have been described with reference to different subject-matters. In particular, some embodiments have been described with reference to apparatus type claims whereas other embodiments have been described with reference to method type claims.

However, a person skilled in the art may gather from the above and the following description that unless other notified in addition to any combination between features belonging to one type of subject-matter also any combination between features relating to different subject-matters in particular between features of the apparatus claims and the features of the method claims may be considered to be disclosed with this application.

### BRIEF DESCRIPTION OF THE DRAWINGS

FIG. 1 shows schematically an exemplary embodiment of a solid state X-ray detector.

FIG. 2 shows schematically an exemplary embodiment of a circuit of an indirect X-conversion detector.

FIG. 3 shows schematically an exemplary embodiment of a circuit of a direct conversion X-ray detector.

FIG. 4 shows schematically a first exemplary embodiment of a circuit according to the invention.

FIG. 5 shows schematically a second exemplary embodiment of a circuit according to the invention.

### DETAILED DESCRIPTION OF EMBODIMENTS

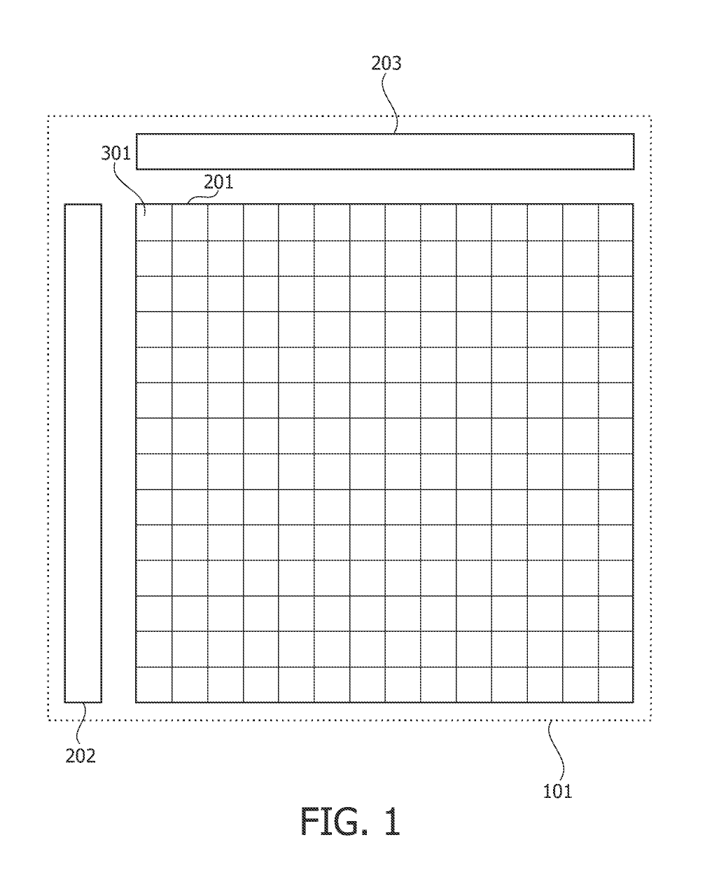

The illustration in the figures is schematic. In the following description of FIGS. 1 to 5, the same reference characters may be used for identical or corresponding elements.

FIG. 1 shows an exemplary embodiment of a solid state X-ray detector 101. The solid state X-ray detector 101 comprises an array 201 of pixel cells 301 and associated line driver circuits 202 and readout amplifiers and/or multiplexers 203.

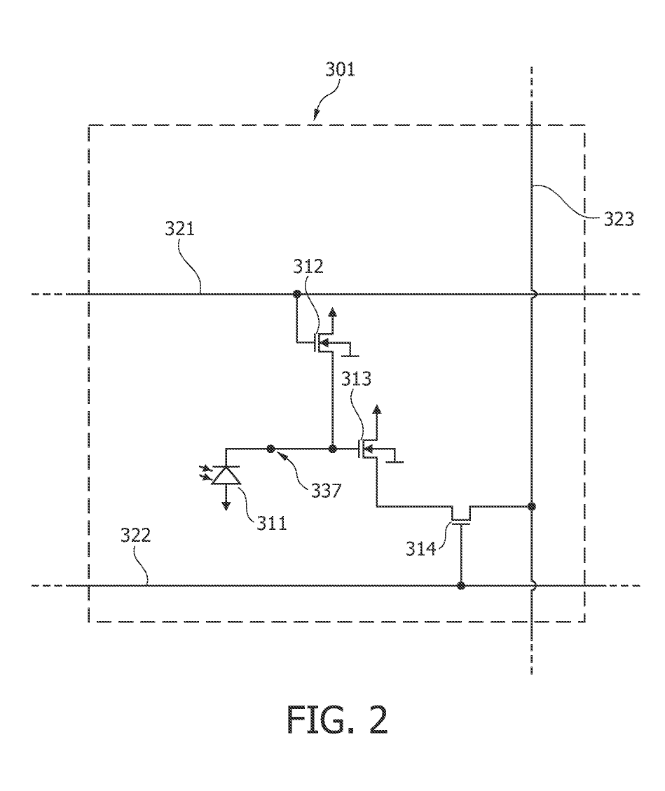

FIG. 2 shows an exemplary embodiment of a circuit of an indirect X-conversion detector. The circuit of FIG. 2 comprises a photodiode 311 which can be reset to a supply voltage by means of a switching device 312 which is controlled by reset line 321. This connection is also referred to an input node 337. The X-ray or light exposure reduces the voltage on the input node 337. During readout, the voltage on this node is copied by a buffer, usually a source follower 313, and placed on the readout line 323 by means of the readout switch 314 which is actuated by the control line 322. It is worth noting that the usual n-channel source follower in a standard CMOS process on a p-epitaxial layer has a gain of approximately 0.8, hence the signal from the input node 337 is copied only in reduced form to the readout line, affecting the achievable signal to noise ratio.

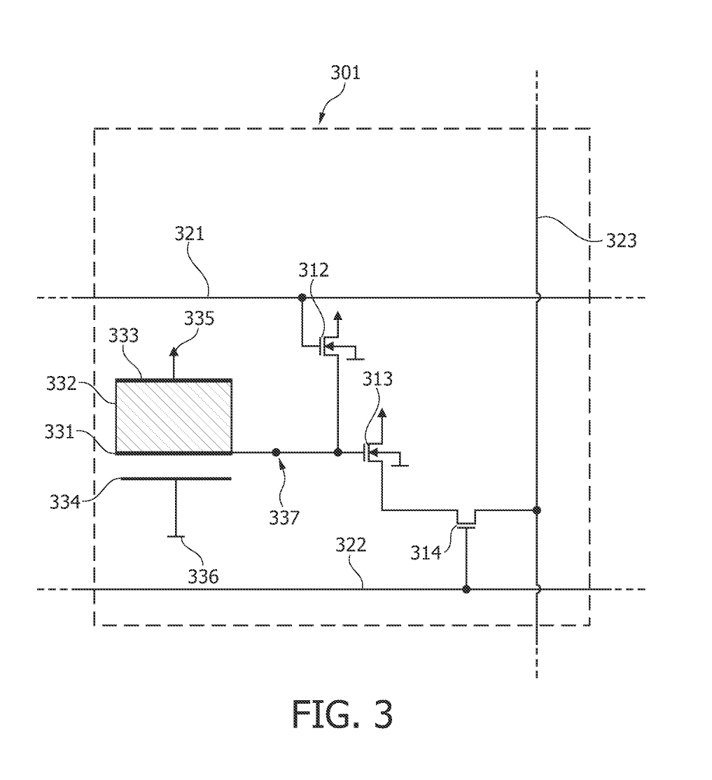

In the case of a direct conversion X-ray detector as shown in FIG. 3, the photodiode 311 is replaced by a charge collection electrode 331 and the shielding electrode 334 which is in first instance connected to a reference potential 336. Further components of the circuit may also be connected to the reference potential 336. The charge collection electrode 331 could be made in the top metal of the backend stack, the reference electrode in the next lower metal layer. The direct conversion material 332 is connected to the charge collection electrode 331 and has also a top contact 333 which is connected to a high voltage supply 335.

The electrodes 331 and 334 form a large part of the input capacitance (C_in), the rest being allocated in the connections, the reset switch 312 and the source follower 313.

The function of the circuit in FIG. 3 is similar to function described for FIG. 2. A difference being that in FIG. 3 the charges collected from the direct conversion material fill the pixel capacitance and hence this may change the voltage on the input node 337.

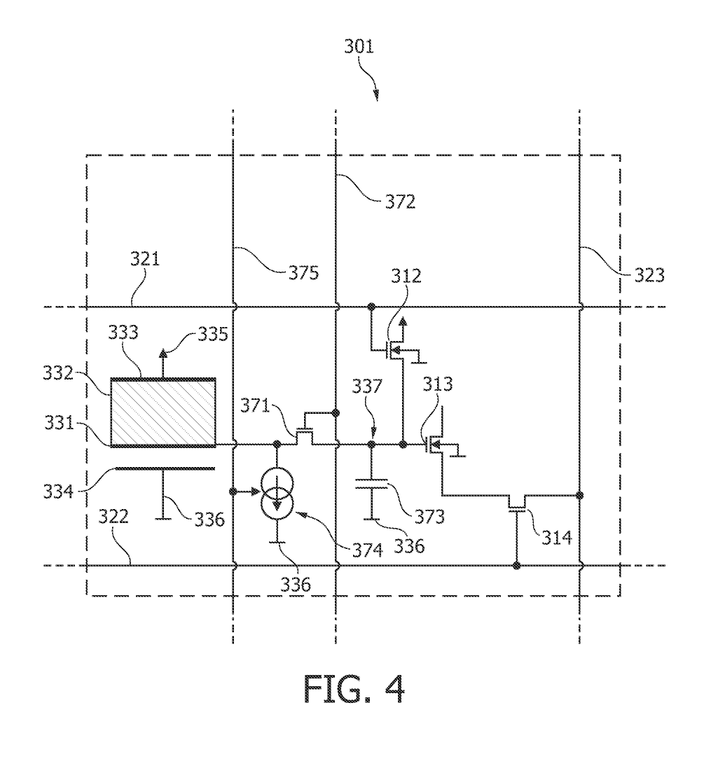

FIG. 4 shows a first exemplary embodiment of a circuit according to the invention. In comparison to FIG. 3, an additional transistor 371 and an integration capacitor 373 are placed between the charge collection electrode 331 and the source follower 313 in the exemplary embodiment of FIG. 4. The gate of the transistor 371 is held by line 372 permanently at such a voltage that a source-drain current can flow if the gate-source voltage exceeds a certain threshold. In case of an X-ray or light exposure of the detector the charge collected at the electrode 331 will be transferred to the integration capacitor 373 and reduces its voltage. The integration capacity is reset after the exposure. To avoid a long term charge accumulation on the charge collection electrode 331, an injection of a small charge may be necessary from time to time, preferably once per X-ray exposure frame, via a charge pump 374, which is controlled by control line 375. This additional charge may be well-known and can be subtracted later from the real signal. In FIG. 4 the charge pump 374, the integration capacitor 373 and the shielding electrode 334 are connected to the reference potential 336, respectively.

The rest of the circuit in FIG. 4 remains the same as in FIG. 3: the voltage on the integration capacity 373 is transferred via a source follower 313 and a readout switch 314 to a readout line 323. The integration capacity 373 can be chosen as small as needed for a specific application leading to a very high sensitivity of the circuit.

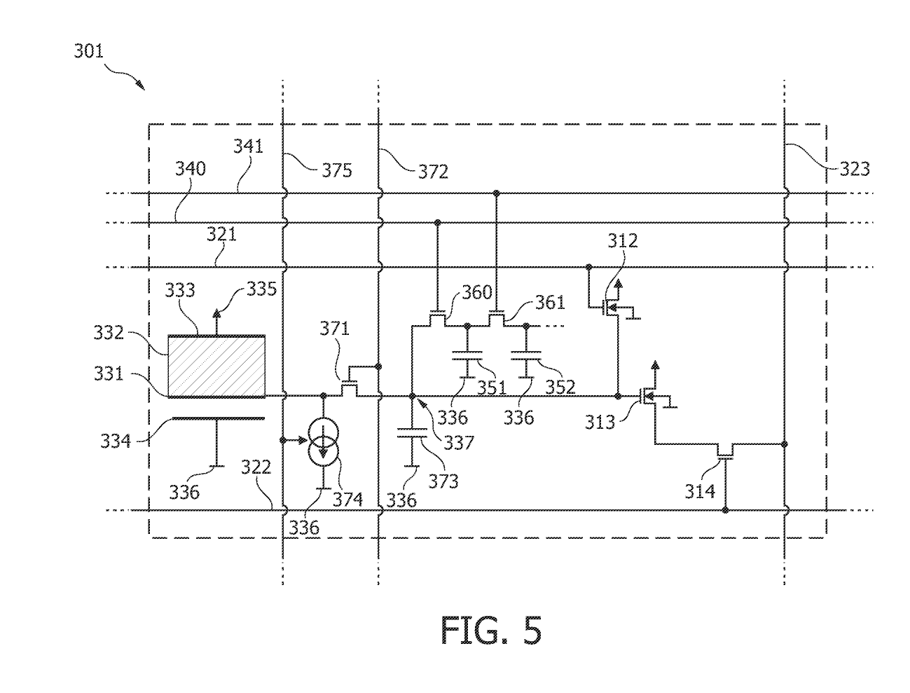

FIG. 5 shows a second exemplary embodiment of a circuit according to the invention. FIG. 5 shows a circuit combined with means to increase the dynamic range of the pixel. One or more charge transfer transistors 360, 361 and one or more additional charge storage capacitors 351, 352 are added to the integration capacitor 373. FIG. 5 shows two additional stages, but changing that to one or more than two stages is easily done by one skilled in the art. The gate voltages of transistors 360, 361 are set by the respective control lines 340, 341 such that the first transistor 360 turns on when the voltage of the integration capacitor 373 has reached a certain lower limit. Further charge arriving through transistor 371 is now transferred to the additional capacitor 351. When the voltage in this capacitor 351 reaches a certain lower limit, the next transistor 361 turns on and transfers further incoming charges to capacitor 352. During readout, a first sub-image is formed by reading the first the capacitor 373 alone. This is achieved by fully turning off charge transfer transistors 360, 361 via their control lines 340, 341. Then a second sub-image is formed by with transistor 360 turned fully on, thus reading the collective charges on 373 and 351. Then a next sub-image is formed by fully turning on both transistors 360, 361, thus the collective charges of 373, 351 and 352 are read. The final image is formed from those sub-images that have valid image information, i.e. those images where no charge has been transferred to a next stage. Thus, the final image can be formed with the smallest integration capacitor which also gives the smallest noise contribution and best signal to noise ratio. All additional capacitors 351, 352 are reset together with 373 by applying a sufficiently high gate voltage over the control lines 340, 341, thus fully activating the transistors 360, 361.

The pixel shown in FIG. 5 can also be used to reduce the sensitivity in fixed steps by fully activating one or more of the transistors 360, 361. This puts capacitors 351 and possibly 352 in parallel to capacitor 373 already during the exposure phase or integration phase. The circuit shown in FIG. 5 is partially self protecting against leakage currents. If the n-MOS reset switch 312 is used with a negative high voltage on the direct conversion material, a high leakage current will turn on the reset switch and the current will be drained to the supply voltage. If positive high voltage is used, a p-MOS reset switch will likewise drain the excessive current and protect the buffer.

With other words, according to an exemplary embodiment of the invention it is provided an additional transistor between the existing large pixel electrode and an additional dedicated and almost smaller integration capacity. The gate of this transistor may be held at a certain intermediate voltage, so that a source-drain current can flow from the pixel electrode to the integration capacity as long as the voltage is above a certain threshold. This charge transfer step may reduce the effective input capacitance, which may be then only determined by the choice of a small integration capacity and the gate of the subsequent source follower amplifier.

In the case of direct conversion solid state X-ray detector, nearly the complete pixel surface may need to act as collection electrode. This electrode is part of the pixel capacitance and is very sensitive to both the input charge and disturbing signals from the underlying electronics. Hence a shielding electrode connected to a reference potential may need to be implemented below the collection electrode to provide a stable second electrode for the pixel capacitor and to keep unwanted disturbing signals from reaching the charge collection electrode.

The arrangement of a charge collection electrode and a shielding electrode forms an input capacitance. The value of this capacitance may be dictated by the pixel size and the actual fabrication process used to build the pixel and is frequently larger than wished for, hence resulting in a low sensitivity of the circuit.

Other possibilities to reduce the input capacitance are to use either bootstrapping circuit as it is proposed in EP2006117527 or a dedicated operational amplifier (OpAmp) in the pixel. In both cases a permanent bias current that is fed in every pixel may be needed, which may be difficult to realize in a large sensor with a higher number of rows.

The invention can be applied to all sorts of X-ray detectors using direct X-ray conversion and pixel electronics using CMOS electronics. The invention may also be applied for photo diodes of optical imagers, using indirect X-ray conversion.

The applications may comprise cardio-vascular X-ray, general X-ray, neurology, orthopaedics, mammography and dental imaging. It may be foreseen to utilize a conversion material reacting to a wavelength of about 1 μm to about 15 μm or infrared radiation on the sensor or the detector unit in order to provide a thermal imaging device.

The invention is not limited to the disclosed embodiments, and gives examples of as many alternatives as possible for the features included in the embodiments discussed.

In addition, it should be pointed out that “comprising” does not exclude other elements or steps, and “a”, “an” or “one” does not exclude a plural number.

Moreover, features cited in separate dependent claims may be advantageously combined.

Furthermore, it should be pointed out that characteristics or steps which have been described with reference to one of the above exemplary embodiments can also be used in combination with other characteristics or steps of other exemplary embodiments described above. Reference characters in the claims are not to be interpreted as limitations.

### LIST OF REFERENCE SIGNS

101 X-ray detector

201 Array

202 Line drive circuit

203 Read out amplifiers/multiplexers

301 Detector unit or pixel cell

311 Photo diode

312 Switching device

313 Source follower, buffer

314 Read out switch

321 Reset line

322 Control line

323 Read out line

331 Charge collection electrode

332 Direct conversion material

333 Top contact

334 Shielding electrode

335 High voltage supply

336 Reference potential

337 Input note

340 Second control line

341 Third control line

351 First charge storage capacitor

352 Second charge storage capacitor

360 First charge transfer transistor

361 Second charge transfer transistor

371 Transistor

372 Fourth control line

373 Integration capacitor

374 Charge pump

375 First control line

1. Detector unit (301) for detecting electromagnetic radiation, the detector unit (301) comprises:
a conversion material (332) adapted for converting impinging electromagnetic radiation into electric charge carriers;
a charge collection electrode (331) adapted for collecting the converted electric charge carriers;
an evaluation circuit (312, 313, 314) adapted for evaluating the electromagnetic radiation based on the collected electric charge carriers; and
a semiconductor (371) which is electrically coupled between the charge collection electrode (331) and the evaluation circuit (312, 313, 314).

2. Detector unit (301) according to claim 1, wherein the semiconductor (371) is a transistor, comprising a gate connection, a drain connection and a source connection, wherein the source connection is connected to the charge collection electrode (331) and wherein the drain connection is connected to the evaluation circuit (312, 313, 314).

3. Detector unit (301) according to claim 2, wherein the gate connection is held to a predetermined voltage wherein the predetermined voltage is adapted to provide a current flow of a source-drain current from the charge collection electrode (331) to the evaluation circuit (312, 313, 314).

4. Detector unit (301) according to claim 2, wherein an integration capacitance (373) is electrically coupled to the semiconductor (371) and to the evaluation circuit (312, 313, 314).

5. Detector unit (301) according to claim 4, wherein the integration capacitance (373) comprises a first connection and a second connection wherein the first connection is connected to the drain connection of the transistor (371) and the second connection is connected to a reference potential (336).

6. Detector unit (301) according to claim 1, wherein the semiconductor (371) is connected to a charge pump (374).

7. Detector unit (301) according to claim 6, wherein the charge pump (374) is adapted to be controlled by a first control line (375).

8. Detector unit (301) according to claim 1, wherein the semiconductor (371) is connected to a first charge transfer transistor (360), which is adapted to be controlled by a second control line (340).

9. Detector unit (301) according to claim 8, wherein the first charge transfer transistor (360) is connected to a first charge storage capacitor (351).

10. Detector unit (301) according to claim 8, wherein the first charge transfer transistor (360) is connected to a second charge transfer transistor (361), which is adapted to be controlled by a third control line (341).

11. Detector unit (301) according to claim 10, wherein the second charge transfer transistor (361) is connected to a second charge storage capacitor (352).

12. A detector device for detecting electromagnetic radiation, the detector device comprising
a plurality of interconnected detector units (301) of claim 1.

13. A method of detecting electromagnetic radiation, the method comprising
converting impinging electromagnetic radiation into electric charge carriers;
collecting the converted electric charge carriers at a charge collection electrode (331);
providing a current flow from the charge collection electrode (331) to an evaluation circuit (312, 313, 314);
evaluating, by the evaluation circuit (312, 313, 314), the electromagnetic radiation based on the collected electric charge carriers.

14. A computer-readable medium, in which a computer program of detecting electromagnetic radiation is stored which, when being executed by a processor, is adapted to control or carry out a method of claim 13.

15. A program element of detecting electromagnetic radiation, which program element, when being executed by a processor, is adapted to control or carry out a method of claim 13.
